(19) United States
(12) Patent Application Publication
(10) Pub. No.: US 2016/0200550 A1
(43) Pub. Date: Jul. 14, 2016

(54) CABLE CLAMP, AND LIFT SYSTEM HAVING A CABLE CLAMP

(71) Applicant: THYSSENKRUPP ELEVATOR AG, Essen (DE)

(72) Inventors: Günter REUTER, Filderstadt (DE); Gerhard SCHIFFNER, Ostfildern (DE); Karl-Otto SCHÖLLKOPF, Esslingen (DE); Herrmann WILTS, Dietzenbach (DE)

(73) Assignee: THYSSENKRUPP ELEVATOR AG, Essen (DE)

(21) Appl. No.: 14/649,023

(22) PCT Filed: Nov. 27, 2013
(86) PCT No.: PCT/EP2013/074872

§ 371 Date: Jun. 2, 2015

(30) Foreign Application Priority Data
Dec. 4, 2012 (DE) 10 2012 111 778.0

(51) Int. Cl. B66B 7/08; B66B 19/02; B66B 9/00

(52) U.S. Cl. CPC B66B 7/08; B66B 9/00; B66B 19/02

(57) ABSTRACT

The invention relates to a cable clamp for a cable of a lift system, having a supporting device which has a wedge receptacle with a first supporting surface and a second supporting surface which is arranged at an angle from the first supporting surface, and having a wedge-shaped clamping device which can be moved to and fro in the wedge receptacle between a clamped position and a released position and has a first clamping surface which lies opposite the first supporting surface and a second clamping surface which lies opposite the second supporting surface, wherein the two clamping surfaces are oriented obliquely with respect to one another. In order to develop the cable clamp in such a way that it makes repeated clamping and releasing of the cable possible with a compact design, without the mechanical load-bearing capability of the cable being impaired appreciably as a result, it is proposed according to the invention that the cable clamp comprises a deflection device and a first clamping region which is arranged between the first clamping surface and the first supporting surface and a second clamping region which is arranged between the second clamping surface and the second supporting surface, wherein the cable to be clamped can be guided through the two clamping regions and can be deflected by mean of the deflecting device from the first clamping region to the second clamping region.

The invention relates to a cable clamp for a cable of an elevator system, in particular for a support cable of an elevator system which is installed in a shaft of a building under construction, having a bearing unit which has a wedge mount, having a first bearing face and a second bearing face which is disposed at an angle to the first bearing face, and having a wedge-shaped clamping unit which is movable to-and-fro in the wedge mount between a clamping position and a releasing position and which has a first clamping face which is opposite the first bearing face and a second clamping face which is opposite the second bearing face, wherein the two clamping faces are obliquely oriented in relation to one another.

Moreover, the invention relates to an elevator system having a cable clamp of this type.

Elevator systems usually have a drive unit which by way of a support cable is linked to a car which is upwardly and downwardly displaceable in a vertical shaft. Often, the car is also connected via the support cable to a counterweight. In high-rise buildings, elevator systems of this type are already required during construction of the buildings in order for construction workers and construction material to be conveyed as close as possible to the floor in which construction work currently is taking place. For this purpose elevator systems are known which are initially installed in a lower shaft region, such that the lower shaft region can be served by the elevator system, and which are relocated upward in the shaft in a stepwise manner as construction progresses, such that the shaft region which may be served by the elevator system is enlarged. Relocating the elevator system to a higher shaft region requires adding length to the support cable or other cables, for example a speed-limiter cable. To this end it may be provided that the cables which are initially used are replaced by longer cables. Alternatively, a cable clamp and a cable reserve may be employed, for example a cable roll, such that the effective length of the cable can be enlarged once the cable clamp has been deactivated, in that an extension portion is removed from the cable reserve and is guided through the cable clamp. Once the desired cable length has been reached, the cable clamp is reactivated, such that the cable having the added length is fixedly clamped.

In order for the initially clamped cable portion to be able to assume a support function once it has been guided out of the cable clamp after release of the cable clamp, it is necessary for the cable clamp not to compromise the mechanical load capacity of the cable, but on the other hand the cable is to be fixedly clamped in a reliable manner by means of the cable clamp.

EP 2 371 753 A1 describes a cable clamp in which in a housing-like bearing unit two pairs of clamping jaws are disposed so as to be vertically offset in relation to one another and the cable to be clamped is guided through the first pair of clamping jaws and through the second pair of clamping jaws. The pairs of clamping jaws are in each case impinged by a pretensioning force by way of a spring which is disposed upstream. The clamping jaws in each case slide by way of a clamping face along an assigned bearing face of the bearing unit and hereby are pressed against the cable. The tensile stress of the cable then leads to the clamping jaws assuming their clamping position in that they jam the cable between them. By means of a cable clamp of this type the cable may be fixedly clamped and released again multiple times; however, the cable clamp has a considerable installation size.

It is an object of the present invention to refine a cable clamp of the type mentioned at the outset in such a manner that, having a compact installation form, said cable clamp enables repeated clamping and releasing of the cable without the mechanical load capacity of the cable being compromised on account thereof.

This object is achieved in a cable clamp of the generic type according to the invention in that the cable clamp comprises a deflection unit and a first clamping region, which is disposed between the first clamping face and the first bearing face, and a second clamping region which is disposed between the second clamping face and the second bearing face, wherein the cable to be clamped is guidable between the two clamping regions and by means of the deflection unit is deflectable from the first clamping region to the second clamping region.

The cable clamp according to the invention has a wedge-shaped clamping unit which defines a first clamping face and a second clamping face. In each case one bearing face of the bearing unit is opposite the clamping faces, and the cable is guided through between the clamping and bearing faces. The wedge-shaped clamping unit may be moved to-and-fro between a clamping position and a releasing position. Once the clamping unit assumes its clamping position, the cable is fixedly clamped in the first clamping region and in the second clamping region. If the clamping action is to be untightened, all that is required is for the clamping unit to be moved into its releasing position, as the cable, on account thereof, is released both in the first clamping region as well as in the second clamping region.

The deflection unit enables the cable to be clamped to be guided in a loop-shaped manner around the clamping unit, such that it may simultaneously be fixedly clamped at two clamping regions which are disposed so as to be offset in relation to one another in the longitudinal direction of the cable once the clamping unit assumes its clamping position, wherein the clamping regions need not be disposed among one another along a straight line; rather, on account of the deflection unit the clamping regions may be positioned so as to be beside one another. The cable clamp thus may have a very compact design and requires only a comparatively small installation space. Therefore, the cable clamp may also be mounted in the case of tight space conditions, for example in a machine room of an elevator system.

In the use position of the cable clamp the first bearing face and the first clamping face may be vertically oriented and the second bearing face and the second clamping face may be obliquely oriented in relation to the vertical. The spacing of the two bearing faces, like the spacing of the two clamping faces, may be upwardly extended in the vertical direction. The cable to be clamped may ingress in the vertical direction from below into the first clamping region, run therethrough upward in the vertical direction, then be deflected by the deflection unit to the second clamping region and then run obliquely therethrough in relation to the vertical from top to bottom, so as to emerge from the second clamping region at the lower end thereof If the cable is subject to tensile stress in the direction of that end of the second clamping region that faces away from the deflection unit, the clamping unit automatically switches over to its clamping position in which the cable is fixedly clamped in the two clamping regions.

In the case of the cable clamp according to the invention, clamping is performed by the cable pull, that is to say that the clamping unit is self-clamping in that the latter, on account of the friction force acting between the cable and the clamping unit, automatically switches over to its clamping position once the cable is subjected to tensile stress. It is thus not mandatory for the clamping unit to be impinged with pretension in order for the former to be switched over to its clamping position by the cable pull. For example, on account of the dead weight of the clamping unit, a sufficiently large friction force between the clamping unit and the cable can be ensured, such that the clamping unit by way of the cable pull automatically switches over to its clamping position.

A particularly compact design of the cable clamp is achieved in one advantageous embodiment of the invention in that the two clamping regions in the use position of the cable clamp are disposed at the same height in relation to the vertical. On account thereof, the vertical extent of the cable clamp may be kept particularly modest.

In one design which in terms of construction is particularly simple, the clamping unit has a clamping wedge. With the aid of the clamping wedge, the cable may be fixedly clamped in a simple manner, both in the first clamping region as well as in the second clamping region.

The deflection unit favorably is held on the clamping unit. This enables the deflection unit to be moved together with the clamping unit, such that the spacing ratios between the clamping unit and the deflection unit are not changed when the clamping unit is moved to-and-fro between its releasing position in its clamping position.

It is favorable for the deflection unit to have a rotatably mounted deflection roller.

It is advantageous for the diameter of the deflection roller to be at least as large as the maximum spacing between the ends of the two clamping regions which face the deflection roller. The cable to be clamped is guided around the deflection roller between the first clamping region and the second clamping region. The radius of the deflection roller corresponds to the bending radius of the cable. The two clamping regions are oriented so as to be oblique in relation to one another, such that their spacing in the direction of the deflection roller is enlarged. On account thereof that the diameter of the deflection roller is at least as large as the maximum spacing of the two clamping regions, it is ensured that the cable to be clamped in the region of the deflection roller is subject to only a comparatively modest bending load.

In one advantageous embodiment of the invention, the two bearing faces and the two clamping faces in each case have one flute-shaped depression which is placeable against the cable surface. In the first clamping region and in the second clamping region the cable in each case may be clamped between a depression of a clamping face and a depression of a bearing face. The depressions receive the cable between them. On account thereof, the risk of the cable being mechanically compromised during clamping may be kept particularly low.

The depressions may be designed so as to be for example V-shaped or curvilinear.

It is particularly advantageous for the depressions to be placeable in a form-fitting manner against the cable surface. In the case of a design of this type the depressions receive the cable to be clamped in a perfect fit between them.

For loosening the cable clamping action, the cable clamp according to the invention has in an advantageous embodiment a manually, electrically, pneumatically, or hydraulically actuatable releasing unit. By means of the releasing unit the clamping unit may be switched over from its clamping position to its releasing position.

Preferably, the releasing unit comprises a piston-and-cylinder unit which is impmgeable by a pressure means, in particular by hydraulic fluid.

It is particularly favorable for the releasing unit in the use position of the cable clamp to be disposed below the clamping unit. On account thereof, the releasing unit may raise the clamping unit counter to the latter's dead weight in order for the clamping action to be untightened.

The bearing unit preferably has two bearing arms which are rigidly interconnected by way of two connection members and in each case define one bearing face. The bearing unit thus configures a housing which surrounds the clamping unit in the circumferential direction. It is advantageous here for the clamping unit to have a clamping wedge which is disposed between the two bearing arms and the two connection members and which has two clamping faces which in each case face one bearing face.

As mentioned at the outset, the invention does not only relate to a cable clamp of the type explained above, but also to an elevator system having a cable clamp of this type. The elevator system comprises a drive unit which by way of a support cable is linked to a car which is upwardly and downwardly displaceable in a vertical shaft. Moreover, the elevator system according to the invention has a cable drum onto which an end portion of the support cable is wound, and a cable clamp of the abovementioned type in which a portion of the support cable is clamped in an untightenable manner. The elevator system may be installed in the shaft of a building under construction, for example. As construction progresses, the elevator system may be upwardly relocated in a stepwise manner in the shaft. The additional length of the support cable which is required here is achieved in a manner which is simple in terms of construction in that a corresponding portion of additional length of the support cable is unwound from the cable drum, after prior untightening of the cable clamp. When the elevator system is vertically relocated in an upward manner in the shaft, the support cable from the cable drum may then run through the cable clamp and the support cable may be fixedly clamped again by means of the cable clamp, once the desired height of the elevator system has been reached. This operation may be repeated multiple times.

In one advantageous embodiment of the elevator system according to the invention the cable drum is disposed in a storage region within or outside the shaft, for example in a shaft basement of the shaft. On account thereof, the weight of the cable drum may be directly supported by the floor of a shaft. Alternatively, it may be provided that the storage region is disposed outside the shaft, for example in an adjoining room.

It is advantageous for both the drive unit and the cable clamp to be disposed in a machine room of the elevator system which is temporarily fixed in the shaft. In order for the elevator system to be operated in a building under construction, the machine room may be temporarily fixed in the shaft. As construction progresses, the machine room may be raised vertically in an upward and stepwise manner The drive unit of the elevator system and the cable clamp are disposed in the machine room. The cable clamp here requires only a comparatively small installation space and may thus also be positioned in the machine room in the case of tight space conditions.

In one advantageous embodiment of the elevator system according to the invention the support cable is guided via at least one deflection element from the car to the cable clamp. The at least one deflection element enables the cable portion coming from the car to be disposed so as to be offset in the horizontal direction in relation to the cable portion which leads from the cable clamp to the cable drum. The cable clamp may be positioned above the cable drum, wherein a first clamping region of the cable clamp is disposed so as to be aligned with that cable portion that connects the cable clamp to the cable drum. The first clamping region in the use position of the cable clamp is thus vertically oriented. Proceeding from the first clamping region, the cable is guided by means of the deflection unit to the second clamping region which is inclined in relation to the vertical and which approaches the first clamping region from top to bottom. From the second clamping region the cable may be guided via at least one deflection element to a deflection roller which is disposed on the roof of the car or of the counterweight, from where the cable then reaches the drive unit.

The following description of an advantageous embodiment of the invention serves as a more detailed explanation in conjunction with the drawing, in which:

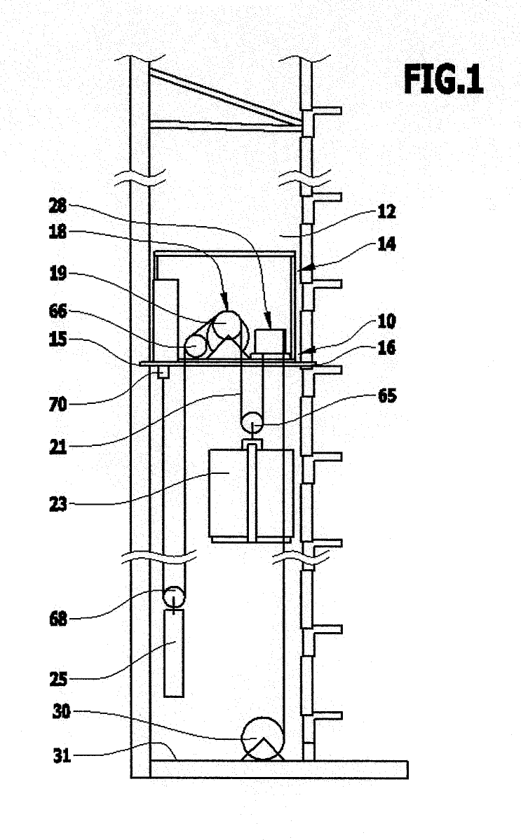

FIG. 1 shows a schematic illustration of an advantageous embodiment of an elevator system according to the invention, which is installed in the shaft of a building under construction;

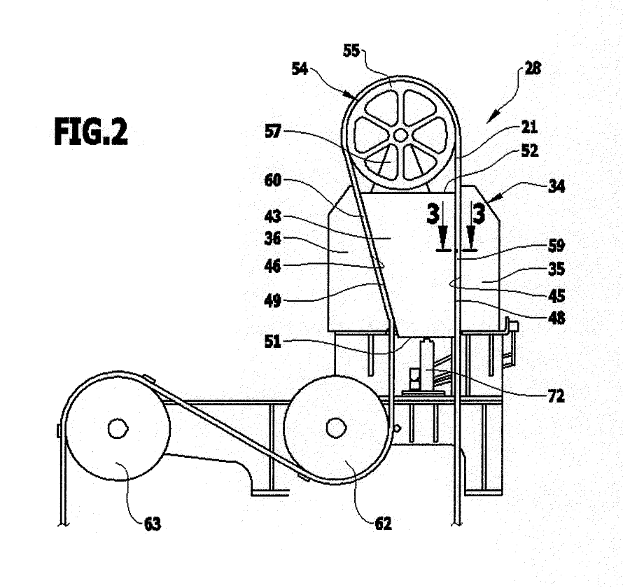

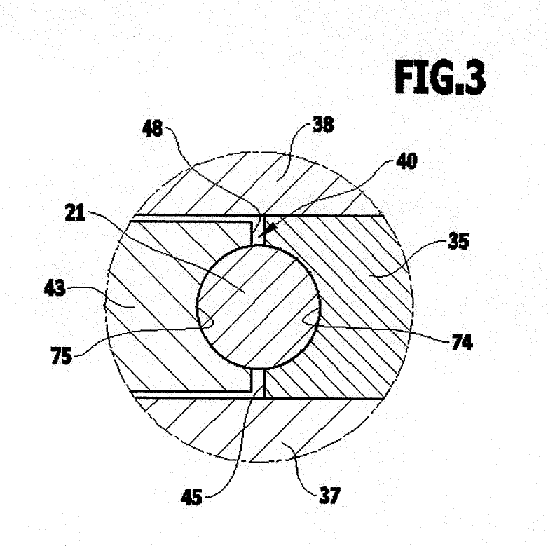

FIG. 2 shows a schematic illustration of an advantageous embodiment of a cable clamp of FIG. 3 shows a lateral view along the line 3-3 of FIG. 2.

In FIG. 1 an elevator system 10 according to the invention, which is installed in a vertical shaft 12 of a building under construction, is illustrated schematically. The elevator system 10 comprises a machine room 14 which is temporarily fixed in the shaft 12 by means of fastening members 15, 16. A drive unit 18 of the elevator system 10 is positioned in the machine room 14. The drive unit 18 has a drive pulley 19 which may be driven in the usual manner by a motor.

The drive unit 18 is linked via a support cable 21 to a car 23 and to a counterweight 25. Moreover, a cable clamp 28 which is illustrated in an enlarged manner in FIG. 2 and through which the support cable 21 is guided is disposed in the machine room 14. One end of the support cable 21 is wound onto a cable drum 30 which is rotatably mounted in a storage region. In the exemplary embodiment illustrated, the storage region is located in a shaft basement 31 of the shaft 12. Alternatively, the storage region could also be disposed outside the shaft 12, for example in an adjoining room.

In order for the elevator system 10 to be operated, the support cable 21 may be fixedly clamped by means of the cable clamp 28. This enables the car 23 to be moved up and down. In order for the car 23 and the counterweight 25 to be guided in the shaft 12, the elevator system 10 has guide rails which are mounted in the shaft and which are known per se to a person skilled in the art and which, therefore, in order to achieve improved clarity in FIG. 1, are not illustrated.

As already mentioned, the elevator system 10 may be installed in the shaft of a building under construction. As construction progresses, the elevator system 10 may be relocated upward in a vertical direction and in a stepwise manner in the shaft 12. To this end, the machine room 14 may be raised after the fastening members 15 and 16 first have been switched over from their holding position illustrated in FIG. 1 to a releasing position. In a higher position the machine room 14 may then be secured again in the shaft 12 by means of the fastening members 15, 16. When the machine room 12 is relocated, the cable clamp 28 is untightened, such that the support cable 21 may be unwound to the required length from the cable drum 30. Once the desired height of the machine room 14 has been reached, the support cable 21 may be fixedly clamped again by means of the cable clamp 28.

The cable clamp 28 comprises a housing-like bearing unit 34 having two bearing arms 35, 36 which vertically protrude upward and which are rigidly interconnected by two connection members 37, 38 which are illustrated in FIG. 3. The bearing arms 35, 36 and connection members 37, 38 surround a wedge mount 40 of the bearing unit 34, which engages through the bearing unit 34 in the vertical direction and in which a clamping unit in the form of a clamping wedge 43 is movably disposed. The bearing arm 35 has a first bearing face 45 which faces the wedge mount 40, and the bearing arm 36 has a second bearing face 46 which faces the wedge mount 40. The clamping wedge 43 comprises a first clamping face 48 which is opposite the first bearing face 45, and a second clamping face 49 which is opposite the second bearing face 46. The first bearing face 45 and the first clamping face 48 are vertically oriented and aligned with the portion of the support cable 21 which connects the cable drum 30 to the cable clamp 28, whereas the second bearing face 46 and the second clamping face 49 are inclined in relation to the vertical, such that the clamping wedge 43, proceeding from a lower end face 51 to an upper end face 52, continuously widens. A deflection unit 54 having a deflection roller 55 which is rotatably mounted on a bearing block 57 which is rigidly connected to the clamping wedge 43 is disposed on the upper end face 52.

A first clamping region 59 of the cable clamp 28 extends between the first bearing face 45 and the first clamping face 48, and a second clamping region 60 of the cable clamp 28 extends between the second bearing face 46 and the second clamping face 49. Proceeding from the cable drum 30, the support cable 21 is guided so as to be vertically oriented through the first clamping region 59; the support cable 21 is guided from the first clamping region 59 via the deflection roller 55 to the second clamping region 60, from which the support cable 21 reaches a first deflection element 62 and a second deflection element 63. From the second deflection element 63 the support cable 21 runs vertically downward up to a third deflection element 65 which is held on the upper side of the car 23. From the third deflection element 65 the support cable 21 runs vertically upward to the drive pulley 19 and to a fourth deflection element 66, from which the support cable 21 is guided vertically downward to a fifth deflection element 68 which is held on the counterweight 25. From the fifth deflection element 68 the support cable 21 runs upward in the vertical direction up to a cable fastening 70 which is disposed on the machine room 14.

The clamping wedge 43 is pressed vertically downward by its dead weight, with the result that it rests on the support cable 21 in the second clamping region 60. The support cable 21 is subjected to tension by the car 23. As a consequence of this, the clamping wedge 43 is automatically moved vertically downward into a clamping position on account of the friction force forming between it and the support cable 21, in which clamping position it fixedly clamps the support cable 21 both in the first clamping region 59 and in the second clamping region 60.

In order for the cable clamp 28 to be untightened, a releasing unit, which in the exemplary embodiment illustrated is designed as a hydraulically impingeable piston-and-cylinder assembly 72, is disposed below the lower end face 51 of the clamping wedge 43. With the aid of the piston-and-cylinder assembly 72 the clamping wedge 43 may be raised, such that the latter is switched over from its clamping position to a releasing position. In the releasing position of the clamping wedge 43 the support cable 21 can run through the cable clamp 28, such that when the elevator system 10 is relocated in the shaft 12 the effective length of the support cable 21 may be enlarged, as has already been explained above.

As is evident from FIG. 3, the bearing faces 45, 46 and the clamping faces 48, 49 are placeable in a form-fitting manner against the support cable 21. To this end, said bearing faces 45, 46 and said clamping faces 48, 49 have in each case one flute-shaped depression 74, 75. It is ensured on account of the form-fitting placement of the bearing faces 45, 46 and clamping faces 48, 49 on the support cable 21 that the support cable 21 is not compromised in its mechanical load capacity, even after repeated clamping and releasing. The deflection of the support cable between the first clamping region 59 and the second clamping region 60 by means of the deflection unit 54 is performed using a comparatively large bending radius, such that the bending stress of the support cable 21 may be kept modest. For this purpose, the diameter of the deflection roller 55 is larger than the mutual spacing of the two clamping regions 59, 60 at the height of the upper end face 52.

On account of the employment of the deflection unit 54 the support cable 21 may be fixedly clamped on two clamping regions 59, 60, which in the vertical direction are disposed at the same height. This imparts a particularly compact design to the cable clamp 28, such that the latter requires only a very small installation space in the machine room 14 of the elevator system 10.

1. A cable clamp for a cable of an elevator system (10), in particular for a support cable (21) of an elevator system (10) which is installed in a shaft (12) of a building under construction, having a bearing unit (34) which has a wedge mount (40), having a first bearing face (45) and a second bearing face (46) which is disposed at an angle to the first bearing face (45), and having a wedge-shaped clamping unit (43) which is movable to-and-fro in the wedge mount (41) between a clamping position and a releasing position and which has a first clamping face (48) which is opposite the first bearing face (45) and a second clamping face (49) which is opposite the second bearing face (46), wherein the two clamping faces (48, 49) are obliquely oriented in relation to one another, characterized in that the cable clamp (28) comprises a deflection unit (54) and a first clamping region (59), which is disposed between the first clamping face (48) and the first bearing face (45), and a second clamping region (60) which is disposed between the second clamping face (49) and the second bearing face (46), wherein the cable to be clamped is guidable between the two clamping regions (59, 60) and by means of the deflection unit (54) is deflectable from the first clamping region (59) to the second clamping region (60).

2. The cable clamp as claimed in claim 1, characterized in that the two clamping regions (59, 60) in the use position of the cable clamp are disposed at the same height in relation to the vertical.

3. The cable clamp as claimed in claim 1 or 2, characterized in that the clamping unit has a clamping wedge (43).

4. The cable clamp as claimed in claim 1, 2, or 3, characterized in that the deflection unit (54) is held on the clamping unit (43).

5. The cable clamp as claimed in one of the preceding claims, characterized in that the deflection unit (54) has a rotatably mounted deflection roller (55).

6. The cable clamp as claimed in claim 5, characterized in that the diameter of the deflection roller (55) is at least as large as the spacing between the ends of the two clamping regions (59, 60) which face the deflection roller.

7. The cable clamp as claimed in one of the preceding claims, characterized in that the two bearing faces (45, 46) and the two clamping faces (48, 49) have flute-shaped depressions (74, 75) which are placeable against the cable surface.

8. The cable clamp as claimed in claim 7, characterized in that the depressions (74, 75) are placeable in a form-fitting manner against the cable surface.

9. The cable clamp as claimed in one of the preceding claims, characterized in that for loosening the cable clamping action, the cable clamp (28) has a manually, electrically, pneumatically, or hydraulically actuatable releasing unit.

10. The cable clamp as claimed in claim 9, characterized in that the releasing unit has a piston-and-cylinder assembly (72) which is impingeable by a pressure means.

11. The cable clamp as claimed in one of the preceding claims, characterized in that the bearing unit (34) has two bearing arms (35, 36) which are rigidly interconnected by way of two connection members (37, 38) and in each case define one bearing face (45, 46), and that the clamping unit has a clamping wedge (43) which is disposed between the two bearing arms (35, 36) and the two connection members (37, 38) and which comprises two clamping faces (48, 49) which in each case face one bearing face (45, 46).

12. An elevator system having a drive unit (18) which by way of a support cable (21) is linked to a car (23) which is upwardly and downwardly displaceable in a vertical shaft (12), and having a cable drum (30) onto which an end portion of the support cable (21) is wound, and having a cable clamp (28) as claimed in one of the preceding claims.

13. The elevator system as claimed in claim 12, characterized in that the cable drum (30) is disposed in a storage region within or outside the shaft (12).

14. The elevator system as claimed in claim 12 or 13, characterized in that the drive unit (18) and the cable clamp (28) are disposed in a machine room (14) of the elevator system (10) which is temporarily fixed in the shaft (12).

15. The elevator system as claimed in claim 12, 13, or 14, characterized in that the support cable (21) is guided via at least one deflection element (62, 63) to a clamping region (60) of the cable clamp (28).
